(19) United States
(12) Patent Application Publication
(10) Pub. No.: US 2019/0198058 A1
(43) Pub. Date: Jun. 27, 2019

(54) IMAGE RECORDING CONTROL APPARATUS, IMAGE RECORDING METHOD, RECORDING MEDIUM STORING IMAGE RECORDING PROGRAM, IMAGE PICKUP APPARATUS, AND IMAGE RECORDING CONTROL SYSTEM

(71) Applicant: OLYMPUS CORPORATION, Tokyo (JP)

(72) Inventor: Taisuke TESHIMA, Tokyo (JP)

(73) Assignee: OLYMPUS CORPORATION, Tokyo (JP)

(21) Appl. No.: 16/201,516

(22) Filed: Nov. 27, 2018

(30) Foreign Application Priority Data
Dec. 21, 2017 (JP) 2017-244971

(51) Int. Cl. G11B 27/031; G11B 27/34

(52) U.S. Cl. CPC G11B 27/031; G11B 27/34

(57) ABSTRACT

An image recording control apparatus includes an image acquisition section configured to acquire a movie and a processor including hardware. The processor is configured to identify at least one image part of a specified time period in length as a record candidate part, from a beginning to an end of the movie, and to identifiably display only frames corresponding to the record candidate part to allow the time period of the record candidate part to be changed or to allow the record candidate part to be selected.

### CROSS REFERENCE TO RELATED APPLICATION

This application is based upon and claims the benefit of priority from the prior Japanese Patent Application No. 2017-244971 filed in Japan on Dec. 21, 2017, the entire contents of which are incorporated herein by reference.

### BACKGROUND OF THE INVENTION

### Field of the Invention

The present invention relates to an image recording control apparatus capable of editing and recording a movie, an image recording method, a recording medium storing an image recording program, an image pickup apparatus, and an image recording control system.

### Description of the Related Art

In recent years, many mobile devices (photographing devices) with a photographing function, such as digital cameras, have a function of not only photographing a still image but also shooting a movie. A movie acquired by shooting includes relatively many useless or monotonous parts in terms of appreciation, and the movie itself may be unvaried and unimpressive in some cases. Accordingly, video editing is performed sometimes to create a movie suitable for appreciation or observation by editing a movie acquired by shooting.

In a video editing apparatus for such movies, relatively-long-time complicated work is required because it is necessary to find desired points to edit from a movie recorded over a long time period and perform editing work. Accordingly, Japanese Patent No. 6206699 discloses a technology in which a digest movie is created in accordance with still image photographing directions, and parts to be deleted are deleted from the digest movie in accordance with predetermined conditions.

### SUMMARY OF THE INVENTION

An image recording control apparatus according to an aspect of the present invention includes: an image acquisition section configured to acquire a movie; and a processor including hardware, wherein the processor is configured to identify at least one image part of a specified time period in length as a record candidate part, from a beginning to an end of the movie, and to identifiably display only frames corresponding to the record candidate part to allow the time period of the record candidate part to be changed or to allow the record candidate part to be selected.

An image recording method according to another aspect of the present invention, includes: acquiring a movie; identifying at least one image part of a specified time period in length as a record candidate part, from a beginning to an end of the movie; and identifiably displaying only frames corresponding to the record candidate part to allow the time period of the record candidate part to be changed or to allow the record candidate part to be selected.

A recording medium storing an image recording program according to a still another aspect of the present invention is configured to cause a computer to execute processes of: acquiring a movie; identifying at least one image part of a specified time period in length as a record candidate part, from a beginning to an end of the movie; and identifiably displaying only frames corresponding to the record candidate part to allow the time period of the record candidate part to be changed or to allow the record candidate part to be selected.

An image pickup apparatus according to an even another aspect of the present invention includes: an image pickup section configured to acquire a movie; and a processor including hardware, wherein the processor is configured to identify at least one image part of a specified time period in length as a record candidate part, from a beginning to an end of the movie, and to identifiably display only frames corresponding to the record candidate part to allow the time period of the record candidate part to be changed or to allow the record candidate part to be selected.

An image recording control system according to an even still another aspect of the present invention includes: an image pickup apparatus configured to acquire a movie; and an information terminal apparatus including a display and capable of communication with the image pickup apparatus, and the image recording control system further includes: a first processor provided in the image pickup apparatus or the information terminal apparatus and including hardware configured to identify at least one image part of a specified time period in length as a record candidate part, from a beginning to an end of the movie; and a second processor provided in the image pickup apparatus or the information terminal apparatus and including hardware configured to identifiably display only frames corresponding to the record candidate part to allow the time period of the record candidate part to be changed or to allow the record candidate part to be selected.

### BRIEF DESCRIPTION OF THE DRAWINGS

FIG. 1 is a block diagram showing an image recording control apparatus according to a first embodiment of the present invention;

FIG. 2 is a flowchart for explaining operations in the first embodiment;

FIG. 3 is an explanatory diagram showing a flow of highlight recording processing;

FIG. 4 is an explanatory diagram showing a display example of a screen display in highlight editing;

FIG. 5 is an explanatory diagram showing a display example of the screen display in the highlight editing;

FIG. 6 is a flowchart showing a flow of processing in highlight editing processing;

FIG. 7 is a block diagram showing a second embodiment of the present invention;

FIG. 8 is a flowchart showing operations of an image pickup apparatus 60;

FIG. 9 is a flowchart showing operations of a mobile terminal 70;

FIG. 10A is an explanatory diagram for explaining operations in the second embodiment;

FIG. 10B is an explanatory diagram for explaining the operations in the second embodiment;

FIG. 10C is an explanatory diagram for explaining the operations in the second embodiment;

FIG. 10D is an explanatory diagram for explaining the operations in the second embodiment; and

FIG. 10E is an explanatory diagram for explaining the operations in the second embodiment.

### DETAILED DESCRIPTION OF THE PREFERRED EMBODIMENT(S)

Hereinafter, embodiments of the present invention will be described in detail with reference to drawings.

### First Embodiment

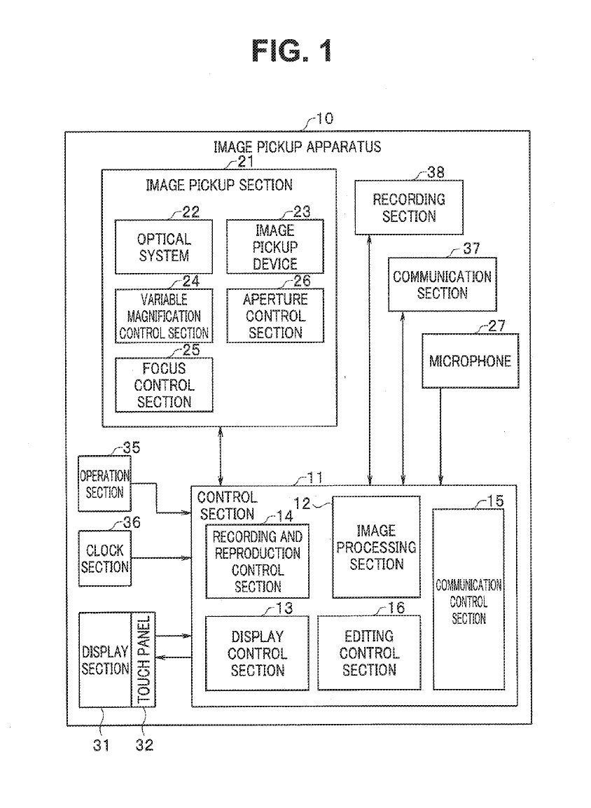

FIG. 1 is a block diagram showing an image recording control apparatus according to a first embodiment of the present invention. The present embodiment illustrates an example in which the image recording control apparatus is configured with an image pickup apparatus.

The image recording control apparatus according to the present embodiment is configured to identify a relatively-short-time candidate for a highlight part in a picked-up image through an operation for specifying a highlight part or through automatic detection of a highlight part and to combine a plurality of the highlight parts at time of shooting or reproducing a movie, whereby the varied and interesting movie is acquired. In this case, in the present embodiment, each candidate for a highlight part is set to have a specified time period (hereinafter, referred to as the candidate period), which is a relatively short time period, in the picked-up image. While such a candidate is, for example, repeatedly reproduced, an operation for changing the candidate period and an operation for combining and editing are accepted from a user, whereby it is possible to create an interesting movie through easy operations. Note that the candidate period is preferably, but is not limited to, for example, a few seconds (two to three seconds, four to five seconds, or the like), comparing and considering easiness of finding and certainty of checking, but can be changed appropriately depending on a content of a movie.

Here, a reason why each candidate for a highlight part is repeatedly displayed is from an idea that it is quicker to see a movie if the movie is a short-time one. However, if each candidate for a highlight part is viewed as a movie, the user can also feel a shift of time and easily check an effect of the movie.

Moreover, for example, in a case of a movie with 30 frames per second, all 60 frames in two seconds may be displayed as still images, or beginning and end frames, as well as other frames and the like, of each candidate part may be displayed as a list of still images. Thus, it is possible to easily check from which point to which point each highlight part ranges. In this case, since the user cannot feel a shift of time, a configuration may be made to display a reproduction time period or the like of a highlight movie at the same time.

The identification of a candidate for a highlight part (hereinafter, referred to as a highlight candidate part) can be performed at any one of time of shooting and time of reproduction. A description below illustrates an example in which a highlight candidate part is identified at time of shooting. However, a highlight candidate part can be identified also at time of reproduction, as at time of shooting. Note that the present embodiment is configured to be able to combine and record highlight candidate parts adopted from among a plurality of highlight candidate parts, which will be described later, and therefore a highlight candidate part can also be said to be a recording candidate part.

In FIG. 1, the image pickup apparatus 10 can be configured with, for example, a digital camera or the like. The image pickup apparatus 10 includes a control section 11. The control section 11 is configured with a processor using a CPU or the like. The control section 11 may be configured to control each section by operating in accordance with a program stored in a memory (not shown), or may be configured to implement part or all of functions by using a hardware electronic circuit.

The image pickup apparatus 10 includes an image pickup section 21 including an image pickup device 23 such as a CCD sensor, a CMOS sensor, or the like. The image pickup section 21 as an image acquisition section acquires an image pickup signal (picked-up image) by photoelectric conversion of an optical image entered via an optical system 22 by using the image pickup device 23. Note that the image pickup device 23 may have pixels for focus control to obtain a defocus amount in image plane phase detection.

The optical system 22 includes lenses and the like (not shown) for zooming and focusing. The optical system 22 includes a zooming (variable magnification) mechanism (not shown) and a focus and aperture mechanism (not shown), which drive the lenses. The zooming mechanism is configured to be driven and controlled by a variable magnification control section 24, while the focus and aperture mechanism is configured to be driven and controlled by a focus control section 25 and an aperture control section 26. Note that the lenses of the optical system 22 may be fixed lenses attached to the image pickup section 21, or may be interchangeable lenses.

The control section 11 is configured to control the variable magnification control section 24, the aperture control section 26, and the focus control section 25 so that zooming, aperture, and focus of the optical system 22 can be adjusted. The image pickup section 21 picks up an image under control of the control section 11 and outputs an image pickup signal of the picked-up image (movie and still images) to the control section 11. The image pickup apparatus 10 also includes a microphone 27. The microphone 27 is configured to collect voice around the image pickup apparatus 10 and supply a voice signal to the control section 11.

The image pickup apparatus 10 includes an operation section 35. The operation section 35 includes a release button, a function button, various switches for shooting mode setting, parameter operation, and the like, a dial, a ring member, and the like, which are not shown in FIG. 1, and outputs an operation signal based on a user operation to the control section 11. The control section 11 is configured to control each section including the image pickup section 21 based on the operation signal from the operation section 35.

Moreover, a touch panel 32 is provided on a display screen of a display section 31, which will be described later. The touch panel 32 can generate an operation signal according to a location on the display screen pointed by the user with a finger. The operation signal is supplied to the control section 11. The control section 11 thus can detect the location on the display screen touched by the user, and also can detect a slide operation made by the user sliding a finger on the display screen. The control section 11 is configured to be able to perform processing corresponding to such a user operation.

The control section 11 outputs a drive signal for driving the image pickup device to the image pickup section 21 and also captures the picked-up image (movie and still images) from the image pickup section 21. An image processing section 12 of the control section 11 performs predetermined signal processing, for example, color adjustment processing, matrix transformation processing, denoising processing, and other various types of signal processing, on the captured picked-up image. Note that the control section 11 also performs predetermined voice signal processing on the voice signal from the microphone 27.

The control section 11 includes a recording and reproduction control section 14. The recording and reproduction control section 14 can perform compression processing on the picked-up image and the voice subjected to the signal processing and provide the compressed image and the compressed voice to a recording section 38 to have the recording section 38 record the compressed image and the compressed voice. The recording section 38 is configured with a predetermined recording medium, and can record information provided from the control section 11 and output recorded information to the control section 11. For the recording section 38, for example, a card interface can be used. The recording section 38 can record image information, voice information, and the like on a recording medium such as a memory card. The recording and reproduction control section 14 can read and use the information recorded in the recording section 38. That is, the recording and reproduction control section 14 can reproduce movie data recorded in the recording section 38 and output the reproduced movie.

The control section 11 includes a display control section 13. The display control section 13 can cause the display section 31 to display the picked-up image, which is provided from the image pickup section 21, or the reproduced image, which is provided from the recording and reproduction control section 14. The display control section 13 is also configured to be able to cause the display section 31 to display a menu display or the like for operating the image pickup apparatus 10. The display section 31 is provided, for example, on a back of a housing of the image pickup apparatus 10 and includes a display screen such as an LCD (liquid crystal display).

The image pickup apparatus 10 includes a communication section 37, and the control section 11 includes a communication control section 15. The communication section 37 is configured to be able to transmit information to and receive information from external equipment (not shown) under control of the communication control section 15. The communication section 37 is capable of communication through, for example, short-range radios such as Bluetooth (registered trademark), and communication through, for example, wireless LAN such as Wi-Fi (registered trademark). Note that the communication section 37 can use communication through various types of communication schemes that are not limited to Bluetooth (registered trademark) and Wi-Fi (registered trademark). The communication control section 15 can transmit movie data acquired by the image pickup section 21 to external equipment or the like via the communication section 37.

The image pickup apparatus 10 includes a clock section 36. The clock section 36 can generate time-of-day information and supply the time-of-day information to the control section 11. The control section 11 can manage time information by using the time-of-day information when editing an image.

In the present embodiment, the control section 11 includes an editing control section 16. The editing control section 16 is configured to be able to identify a starting point of a highlight part in the picked-up image based on user operations of the touch panel 32 and the operation section 35 during image pickup. For example, the editing control section 16 as an identification section may be configured to set a timing when a user operation is carried out as a starting point of a highlight candidate part, and to identify the picked-up image as long as the candidate time period as the highlight candidate part. Alternatively, the editing control section 16 may be configured to set a timing a predetermined time period earlier than a timing when a user operation is carried out as a starting point of a highlight candidate part, and to identify the picked-up image as long as the candidate time period as the highlight candidate part. Note that when voice of the user can be picked up during recording, a configuration may be made such that the control section 11 is caused to perform voice recognition processing, and a starting point of a highlight candidate part is identified based on a result of recognition of the voice acquired by the microphone 27.

In the present embodiment, the image processing section 12 is configured to be able to perform image analysis for determination of a highlight candidate part performed by the editing control section 16. For example, the image processing section 12 can calculate an evaluation value for determining, for example, an image including a greatly varying motion, an image of appropriate brightness, and the like by obtaining luminance distribution, luminance differential value distribution, motion vector distribution, and the like for each frame of the picked-up image. The image processing section 12 can calculate an evaluation value for detecting human being and animal faces and the like in the picked-up image through publicly known face recognition processing. In addition, for example, the image processing section 12 can calculate evaluation values used for determination of a highlight part in various events by comparing image characteristics of the picked-up image with image characteristics of various images such as specific scenes in sports and specific backgrounds.

The editing control section 16 is configured to be able to identify a highlight candidate part in the picked-up image based on the evaluation values calculated by the image processing section 12. Note that in this case, the highlight candidate part is also as long as the predetermined candidate time period. The editing control section 16 may be configured to set a timing a predetermined time period earlier than a starting timing of the highlight candidate part based on the evaluation values calculated by the image processing section 12 as a starting point of the highlight candidate part, and to identify the picked-up image as long as the candidate time period as the highlight candidate part. The editing control section 16 is configured to be able to set the candidate time period based on a user operation.

The editing control section 16 is configured to control the recording and reproduction control section 14 to cause the recording and reproduction control section 14 to record the picked-up image in the recording section 38 in such a manner that in the picked-up image, the highlight candidate part and an image corresponding to the other time period than the candidate time period can be distinguished from each other. For example, the editing control section 16 may regard a time period corresponding to the candidate time period starting from a timing of a user operation or a timing based on the evaluation values from the image processing section 12, which designates the starting point of the highlight candidate part, as an actual recording time period, and regard the other time period as a provisional recording time period, and then make the picked-up image corresponding to the actual recording time period to be recorded as actual-recording record data, and make the picked-up image corresponding to the provisional time period to be recorded as provisional-recording record data. Note that the editing control section 16 may be configured to set indexes indicating the actual recording time period and the provisional recording time period corresponding to the recording record data of the picked-up image, and to distinguish between the provisional recording time period and the actual recording time period by using the indexes.

The editing control section 16 as a selection section and a time period change section is configured to control the display control section 13 so that while each highlight candidate part is, for example, repeatedly displayed on the display screen of the display section 31, the display control section 13 provides a GUI (graphical user interface) for selection of the highlight candidate part, setting of the candidate time period by changing starting and ending points of the highlight candidate part, combining of any highlight candidate parts, the respective candidate time periods of which are reset, and the like. Note that the editing control section 16 only needs to identifiably display frames corresponding to a highlight candidate part. Frames other than the frames corresponding to a highlight candidate part may be displayed, and each highlight candidate part does not need to be repeatedly displayed.

The editing control section 16 is configured to control the recording and reproduction control section 14 in accordance with results of user operations so that a combined image obtained by combining the highlight candidate parts, the picked-up image before combining, and the like can be recorded in the recording section 38.

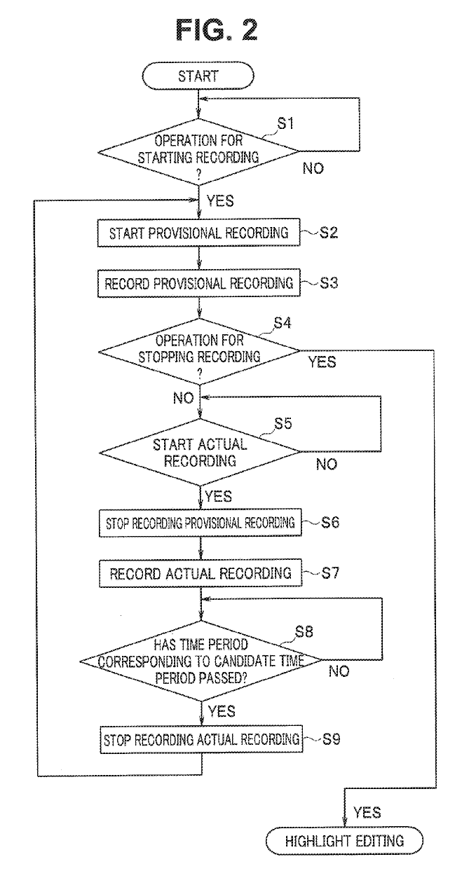

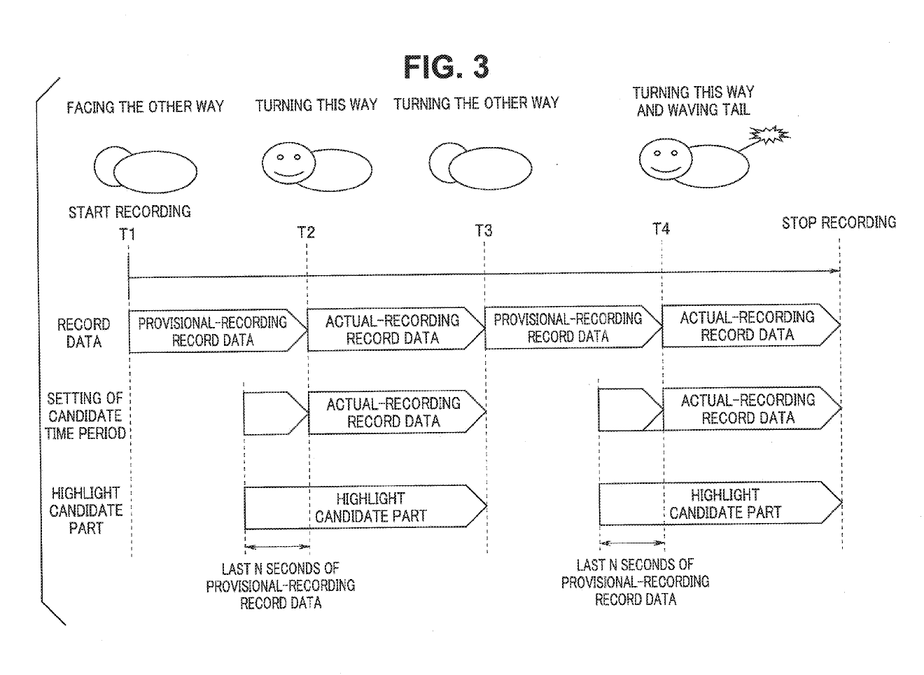

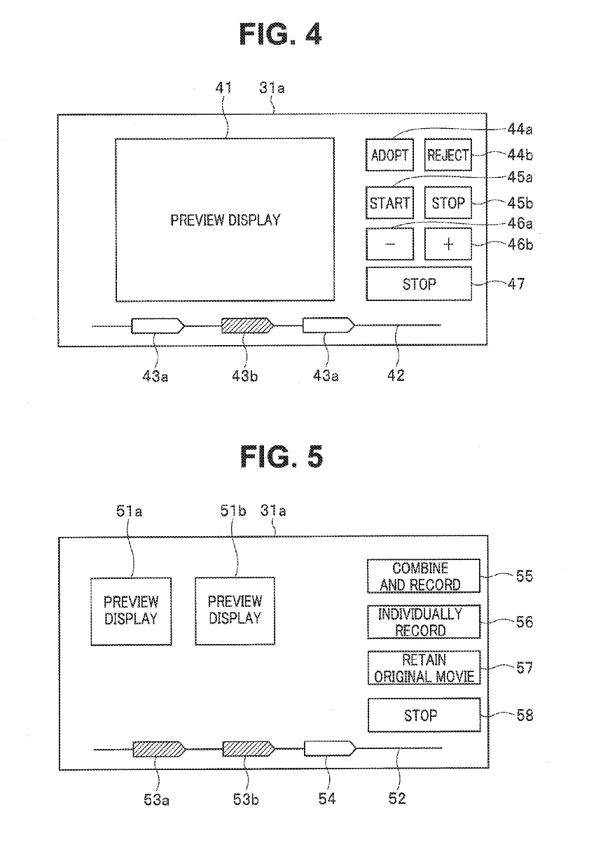

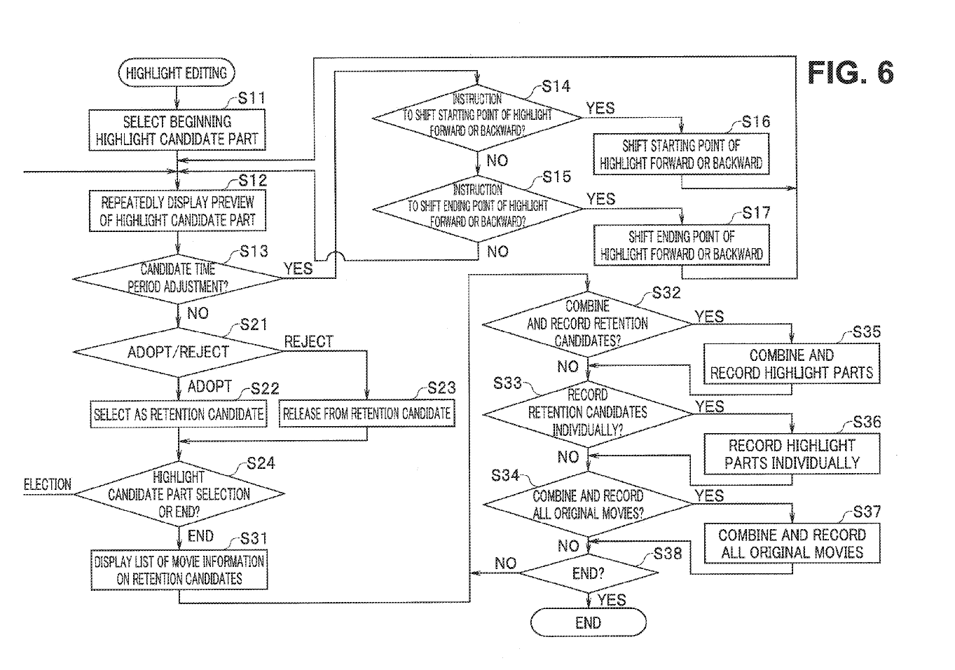

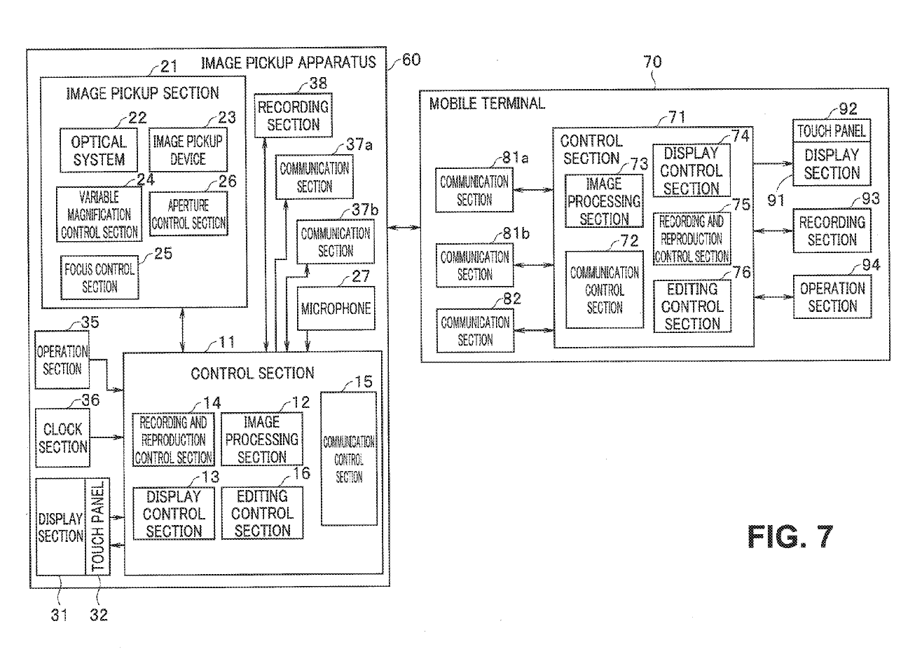

Next, operations in the thus configured embodiment will be described with reference to FIGS. 2 to 6. FIG. 2 is a flowchart for explaining operations in the first embodiment. FIG. 3 is an explanatory diagram showing a flow of highlight recording processing. FIGS. 4 and 5 are explanatory diagrams showing display examples of a screen display in highlight editing. FIG. 6 is a flowchart showing a flow of processing in highlight editing processing.

Now, an example of shooting a pet such as a cat as an object will be described. FIG. 3 shows a relationship between states of the cat and record data, with a horizontal axis representing time. FIG. 3 shows that the cat faces the other way (toward the opposite side to the image pickup apparatus 10) at timings T1 and T3, the cat turns the face this way (toward the image pickup apparatus 10 side) at a timing T2, and the cat turns the face this way and waves the tail at a timing T4.

It is assumed that a user desires to shoot a movie of the cat in a state where the cat turns the face this way. However, even if the user intends to shoot a movie of the cat only in such a state and waits to shoot, a state of the cat in future cannot be predicted. Even if the user starts shooting in wait for a chance, the user may miss a timing of shooting sometimes. Accordingly, in the present embodiment, the user starts shooting the cat, including a scene in which the cat does not turn this way.

In step S1, the control section 11 of the image pickup apparatus 10 is in a shooting wait state where it is determined whether or not an operation for starting shooting is carried out. For example, it is assumed that an operation for starting shooting is carried out at the timing T1 in FIG. 3. When the editing control section 16 determines that an operation for starting shooting is carried out, the editing control section 16 starts provisional recording of a picked-up image (step S2).

That is, the image pickup section 21 starts picking up an image for a movie of the cat facing the other way and outputs the picked-up image to the control section 11. The image processing section 12 performs the predetermined signal processing on the inputted picked-up image. The recording and reproduction control section 14 sequentially records the picked-up image subjected to the signal processing as provisional-recording record data in the recording section 38 (step S3). Next, in step S4, the editing control section 16 determines whether or not an operation for stopping recording is carried out.

When an operation for stopping recording is not performed, the editing control section 16 determines whether or not to start actual recording during the provisional recording (step S5). For example, the editing control section 16 starts actual recording when an operation designating a starting point of a highlight candidate part is carried out by the user. Now, it is assumed that the user instructs to start actual recording by operating the operation section 35 and the touch panel 32 when the cat turns the face this way at the timing T2. Then, the editing control section 16 controls the recording and reproduction control section 14 to stop the provisional recording (step S6) and to start actual recording (step S7).

The actual recording is continued until a time period corresponding to the candidate time period passes from the start of the actual recording. When the time period has passed, the editing control section 16 controls the recording and reproduction control section 14 to stop the actual recording (step S9), and then processing is moved back to step S2, where provisional recording is started again. Thereafter, the processing in steps S2 to S9 is repeated, and provisional recording and actual recording are performed. The example of FIG. 3 shows that the provisional recording shifts to actual recording again at the timing T4 based on an operation by the user who recognizes that the cat turns this way and waves the tail at the timing T4.

In step S4, when the editing control section 16 determines that an operation for stopping recording is carried out, the editing control section 16 stops the provisional recording and shifts to highlight editing processing. Note that when an operation for stopping recording is carried out during actual recording, the editing control section 16 terminates recording processing after stopping the actual recording, and then shifts to highlight editing processing. The example of FIG. 3 shows an example in such a case.

As described above, in the present embodiment, provisional recording is started in accordance with a user operation for starting recording, and at a timing designated by the user, actual recording is performed only for a time period corresponding to the candidate time period.

In the example of FIG. 3, the editing control section 16 sets a time period of actual recording plus a predetermined time period (n seconds) of provisional recording immediately before the actual recording as the candidate time period, and regards provisional-recording record data and actual-recording record data corresponding to the candidate time period as recording record data of a highlight candidate part. In this manner, the highlight candidate part includes the last predetermined time period of provisional recording, whereby even if actual recording is started after a delay of the predetermined time period from a timing when the user recognizes a highlight candidate part, it is possible that the highlight candidate part includes a beginning part of the highlight candidate part recognized. Note that the editing control section 16 may set only the time period of actual recording as the candidate time period, and regard the actual-recording record data as record data of the highlight candidate part.

Next, the highlight editing processing will be described with reference to FIGS. 4 to 6. When an operation for stopping recording is carried out, the editing control section 16 shifts to the highlight editing processing and controls the display control section 13 so that preview screen display processing is performed.

FIG. 4 shows such a preview display screen. A preview display section 41 is provided in an approximate center of a display screen 31a of the display section 31. A time line bar 42 is provided at a lower end of the display screen 31a. The time line bar 42 indicates a time axis for a picked-up image. A left end of the time line bar 42 corresponds to a starting point of the picked-up image, and a right end of the time line bar 42 corresponds to an ending point of the picked-up image. Marks “43a” and “43b” on the time line bar 42 represent highlight candidate parts, a shaded one of which represents a highlight candidate part currently selected. Note that the shades represent coloring, patterns, brightness, and the like different from others in actuality. The example of FIG. 4 shows that highlight candidate parts are set at three locations in the picked-up image, and the highlight candidate part denoted by the second mark “43b” is displayed on the preview display section 41 (not shown).

Note that when the user touches the mark “43a” or “43b”, the editing control section 16 can select one of the highlight candidate parts corresponding to the touched mark “43a” or “43b” and cause the preview display section 41 to display the selected highlight candidate part. Moreover, the editing control section 16 may be configured to change highlight candidate parts to be displayed on the preview display section 41 by the user carrying out, for example, a slide operation from side to side on the touch panel 32 of the preview display section 41.

In the highlight editing processing, the editing control section 16 first selects the beginning one of the highlight candidate parts in step S11 of FIG. 6 and displays a preview of the selected highlight candidate part on the preview display section 41 (step S12). Note that the preview display section 41 only needs to be able to identifiably display frames corresponding to the highlight candidate part. Accordingly, the preview display section 41 may display only frames corresponding to the highlight candidate part, or may distinguishably display frames corresponding to the highlight candidate part and other frames. The preview display section 41 may, or does not need to, repeatedly display the highlight candidate part.

The editing control section 16, through the display control section 13, provides the GUI for processing for changing the candidate time period of the highlight candidate part. In the example of FIG. 4, the display control section 13 displays an adopt button 44a, a reject button 44b, a start button 45a, a stop button 45b, a minus button 46a for moving time back, a plus button 46b for moving time forward, and a stop button 47 on a right end of the display screen 31a.

In step S13, the editing control section 16 determines whether or not the candidate time period is adjusted by the user. When an operation for adjustment is carried out, the editing control section 16, in step S14, determines whether or not an operation for moving the starting point of the highlight forward or backward is carried out, and in step S15, determines whether or not an operation for moving the ending point of the highlight forward or backward is carried out.

The user operates the start button 45a and thereafter operates the minus button 46a or the plus button 46b, whereby the editing control section 16 moves processing from step S14 to step S16 and can shift the starting point of the highlight candidate part displayed on the preview display section 41 to earlier time or to later time. Similarly, the user operates the stop button 45b and thereafter operates the minus button 46a or the plus button 46b, whereby the editing control section 16 moves processing from step S15 to step S17 and can shift the ending point of the highlight candidate part displayed on the preview display section 41 to earlier time or to later time.

The editing control section 16 moves processing from step S16 or S17 back to step S12, where a preview display is continued. Thus, the user can change the candidate time period of each highlight candidate part while checking a preview display of each highlight candidate part. Note that a user operation of changing the candidate time period is reflected on a preview display.

When an operation for adjustment is not carried out in step S13, the editing control section 16 moves processing to step S21 and determines whether or not to adopt the highlight candidate part of the adjusted candidate time period. When the user operates the adopt button 44a, the editing control section 16 adopts the selected and preview-displayed highlight candidate part to select as a retention candidate (step S22). When the user operates the reject button 44b, the editing control section 16 does not adopt the selected and preview-displayed highlight candidate part and releases the highlight candidate part from a retention candidate (step S23).

In subsequent step S24, the editing control section 16 determines whether an operation for selecting another highlight candidate part is carried out or an operation of the stop button 47 is carried out. When an operation for selecting another highlight candidate part is carried out, the editing control section 16 moves processing back to step S12 and displays a preview of the selected highlight candidate part. When an operation of the stop button 47 is carried out, the editing control section 16 moves processing to step S31, displays a list of movie information on the retention candidate, and then advances to highlight recording processing.

The candidate time period of each highlight candidate part is set relatively short, considering a time period that allows the user to certainly do checking, and the user can check each highlight candidate part specified within the short time period. Moreover, even if relatively-long-time recording is performed as a whole, each highlight candidate part can be checked for a relatively short time period, and a change of the candidate time period and adoption or rejection of the highlight candidate part can be performed through easy operations. Accordingly, the user can extremely easily confirm highlight candidate parts for acquiring a varied and interesting movie.

FIG. 5 shows a list display displayed in step S31. A plurality of preview display sections 51a and 51b are provided in the approximate center of the display screen 31a of the display section 31. A time line bar 52 is provided at the lower end of the display screen 31a. The time line bar 52 indicates a time axis for a picked-up image. A left end of the time line bar 52 corresponds to a starting point of the picked-up image, and a right end of the time line bar 52 corresponds to an ending point of the picked-up image. Marks “53a”, “53b”, and “54” on the time line bar 52 represent highlight candidate parts set during image pickup, shaded ones of which represent the highlight candidate parts adopted in step S21. Note that the shades represent coloring, patterns, brightness, and the like different from others in actuality.

The example of FIG. 5 shows that two highlight candidate parts denoted by the marks “53a” and “53b” among the three highlight candidate parts are adopted, and the adopted highlight candidate parts are displayed on the preview display sections 51a and 51b, respectively (not shown). Note that although FIG. 5 shows an example in which only the two preview display sections 51a and 51b are displayed, the editing control section 16 is configured to display previews of all highlight candidate parts adopted. Thus, the user can see the adopted highlight candidate parts on a single view and easily predict a movie that can be acquired after editing.

The editing control section 16, through the display control section 13, displays a combine and record button 55, an individually record button 56, a retain original movie button 57, and a stop button 58 on the right end of the display screen 31a. In the highlight recording processing, the editing control section 16 determines in step S32 whether or not the combine and record button 55 is operated so that it is designated to combine and record the retention candidates. In step S33, the editing control section 16 determines whether or not the individually record button 56 is operated so that it is designated to record each retention candidate individually. In step S34, the editing control section 16 determines whether or not the retain original movie button 57 is operated so that it is designated to record a movie made of a series of the provisional-recording and actual-recording record data.

When the combine and record button 55 is operated, the editing control section 16 moves from step S32 to step S35 and controls the recording and reproduction control section 14 so that the retention candidates are combined and recorded. When the individually record button 56 is operated, the editing control section 16 moves from step S33 to step S36 and controls the recording and reproduction control section 14 so that each of the retention candidates is recorded individually. When the retain original movie button 57 is operated, the editing control section 16 moves from step S34 to step S37 and controls the recording and reproduction control section 14 so that a movie made of a series of the provisional-recording and actual-recording record data is recorded.

When the editing control section 16 determines that none of the buttons 55 to 57 is operated in steps S32 to S34, the editing control section 16 determines in subsequent step S38 whether or not the stop button 58 is operated. When the stop button 58 is operated, the editing control section 16 terminates processing. When the stop button 58 is not operated, the editing control section 16 moves processing back to step S32 and waits to determine whether or not any of the buttons 55 to 58 is operated. In this manner, the candidate time periods of the highlight candidate parts adopted by the user are adjusted as necessary, and thereafter the highlight candidate parts are combined and recorded, or individually recorded. Thus, the user can easily create a varied and interesting movie.

As described above, in the present embodiment, highlight candidate parts of the relatively short candidate time period are set at time of shooting, and a user operation for changing the candidate time period and a user operation for combining and editing are accepted while each highlight candidate part is repeatedly reproduced, whereby it is possible to create a varied and interesting movie desired by the user through simple operations.

### Second Embodiment

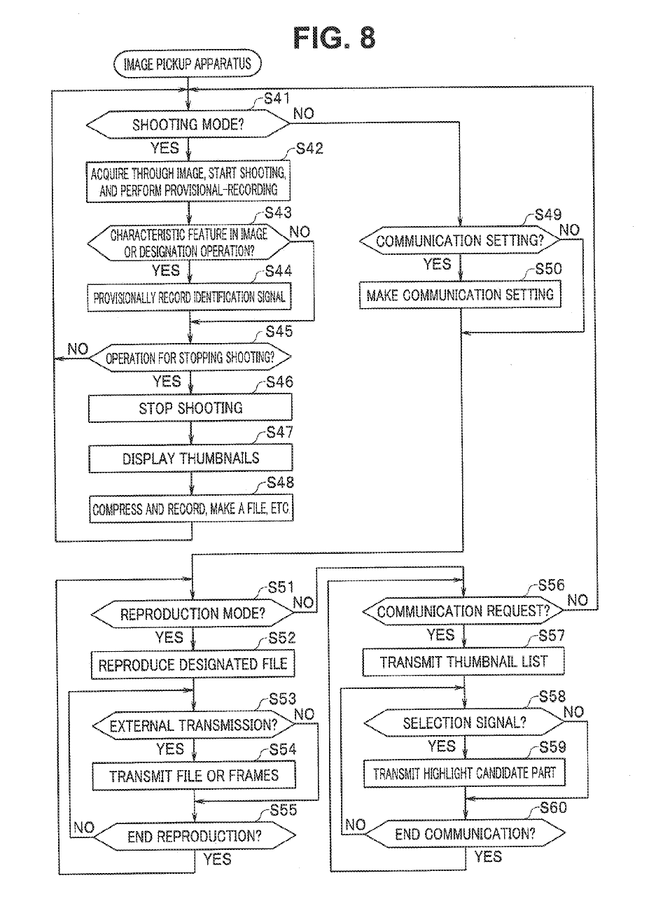

FIG. 7 is a block diagram showing a second embodiment of the present invention. In FIG. 7, same constituent elements as the constituent elements in FIG. 1 are denoted by the same reference signs, and a description of such constituent elements will be omitted. The present embodiment illustrates an example in which an image recording control apparatus is configured with an image pickup apparatus and a mobile terminal.

In the present embodiment, part or all of the processing in the highlight candidate part identification processing, the highlight editing processing, and the highlight recording processing in the first embodiment is performed by a mobile terminal 70. If all of the processing is implemented by the mobile terminal 70 as an information terminal apparatus, an image pickup apparatus 60 only needs to have, as a minimum function, a function of picking up an image of an object and transmitting the picked-up image to external equipment or the like, and the image pickup apparatus 10 in the first embodiment may be used for the image pickup apparatus 60. That is, although the editing control section 16 in FIG. 1 controls all of the processing in the highlight candidate part identification processing, the highlight editing processing, and the highlight recording processing, the editing control section 16 in the present embodiment may perform only part of the processing, or does not need to perform any of the processing at all.

In the example of FIG. 7, the image pickup apparatus 60 is different from the image pickup apparatus 10 in that communication sections 37a and 37b are provided in place of the communication section 37. The communication sections 37a and 37b are configured to be able to transmit information to and receive information from external equipment under control of the communication control section 15. The communication section 37a is capable of communication through, for example, wireless LAN such as Wi-Fi (registered trademark), while the communication section 37b is capable of communication through, for example, short-range radios such as Bluetooth (registered trademark). Note that the communication sections 37a and 37b can use communication through various types of communication schemes that are not limited to Bluetooth (registered trademark) and Wi-Fi (registered trademark). The communication control section 15 can transmit movie data via the communication section 37a or 37b.

On the other hand, the mobile terminal 70 can be configured with, for example, a smartphone. The mobile terminal 70 includes a control section 71. The control section 71 is configured with a processor using a CPU or the like. The control section 71 may be configured to control each section by operating in accordance with a program stored in a memory (not shown), or may be configured to implement part or all of functions by using a hardware electronic circuit.

The mobile terminal 70 includes communication sections 81a, 81b, and 82, and the control section 71 includes a communication control section 72 configured to control the communication sections 81a, 81b, and 82. The communication section 81a is capable of communication through, for example, wireless LAN such as Wi-Fi (registered trademark). The communication section 81b is capable of communication through, for example, short-range radios such as Bluetooth (registered trademark). The communication section 82 is capable of communication using a public telephone circuit. Thus, the image pickup apparatus 60 and the mobile terminal 70 can communicate with each other via the communication sections 37a and 81a, and also via the communication section 37b and 81b. An image from the image pickup apparatus 60 can be received by the communication sections 81a and 81b, and the communication sections 81a and 81b function as an image acquisition section.

The mobile terminal 70 includes a display section 91, a touch panel 92, a recording section 93, and an operation section 94. Components of the display section 91, the touch panel 92, the recording section 93, and the operation section 94 are similar to the components of the display section 31, the touch panel 32, the recording section 38, and the operation section 35 of the image pickup apparatus 60, respectively. The control section 71 includes an image processing section 73 configured to perform image processing, a display control section 74 configured to control a display on the display section 91, and a recording and reproduction control section 75 configured to control recording and reproduction by the recording section 93. Components of the image processing section 73, the display control section 74, and the recording and reproduction control section 75 are similar to the components of the image processing section 12, the display control section 13, and the recording and reproduction control section 14 of the image pickup apparatus 60, respectively.

The control section 71 includes an editing control section 76. The editing control section 76 has a configuration similar to the configuration of the editing control section 16 and is configured to supplement the functions of the editing control section 16 with respect to the highlight candidate part identification processing, the highlight editing processing, and the highlight recording processing. The editing control section 76 only needs to be able to perform processing other than the processing performed by the editing control section 16, with respect to the highlight candidate part identification processing, the highlight editing processing, and the highlight recording processing. For example, if the editing control section 16 performs only the highlight candidate part identification processing, the editing control section 76 only needs to be configured to perform the highlight editing processing and the highlight recording processing.

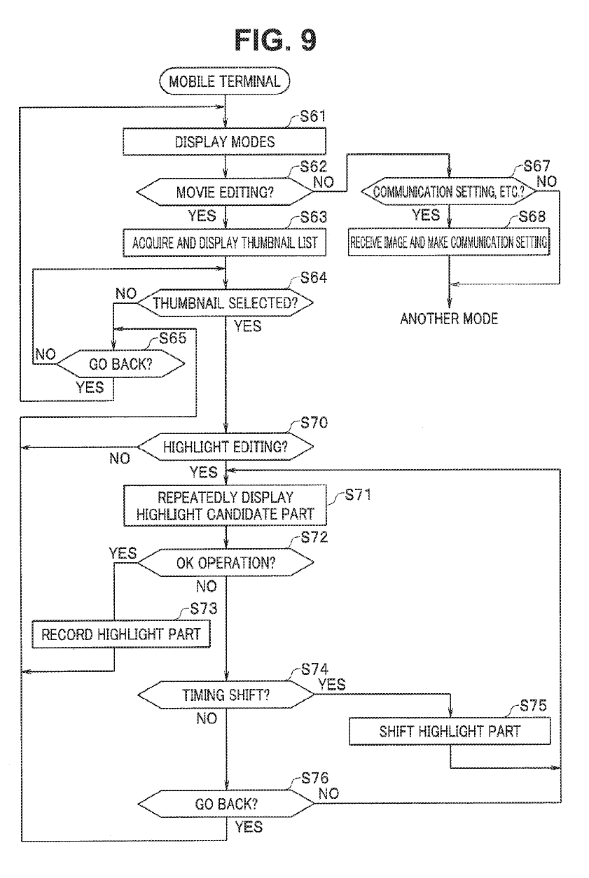

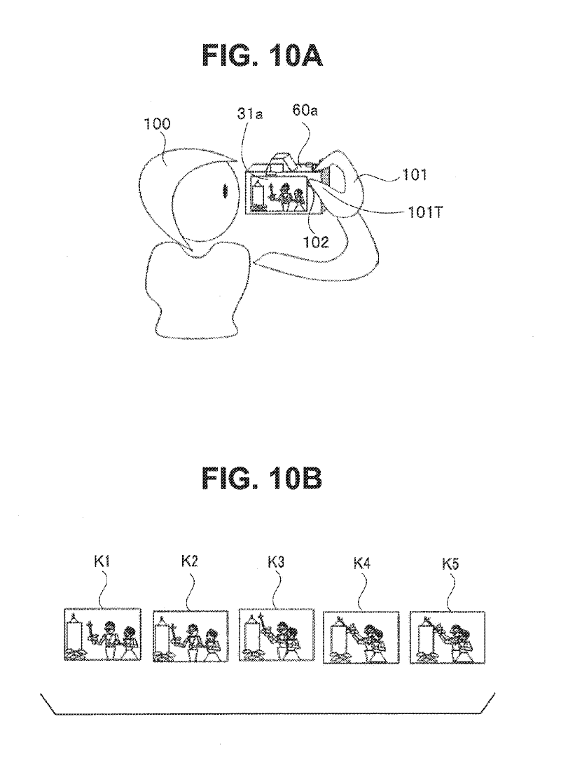

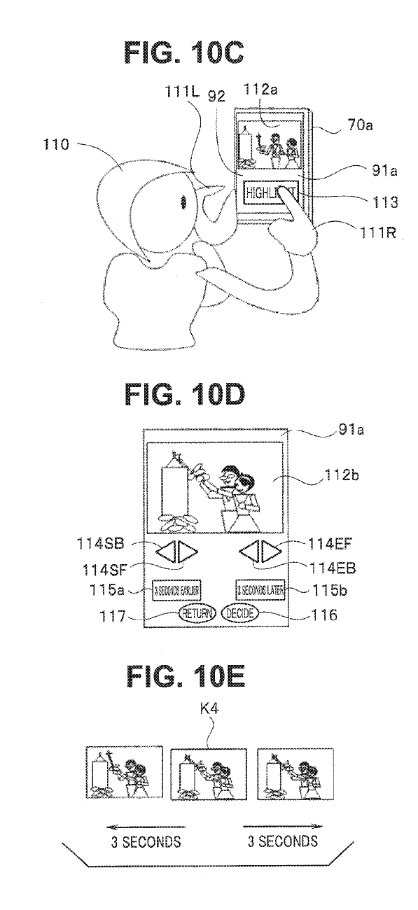

Next, operations in the thus configured embodiment will be described with reference to FIGS. 8, 9, and 10A to 10E. FIG. 8 is a flowchart showing operations of the image pickup apparatus 60. FIG. 9 is a flowchart showing operations of the mobile terminal 70. FIGS. 10A to 10E are explanatory diagrams for explaining operations in the second embodiment.

In the present embodiment, the image pickup apparatus 60 and the mobile terminal 70 perform the highlight candidate part identification processing, the highlight editing processing, and the highlight recording processing on a movie shot by the image pickup apparatus 60. For example, an example will be described in which the image pickup apparatus 60 performs only the highlight candidate part identification processing, and the mobile terminal 70 performs the highlight editing processing and the highlight recording processing.

FIG. 10A shows a situation in which a movie is shot at a wedding. As shown in FIG. 10A, the display screen 31a of the display section 31 is provided on a back of a housing 60a accommodating each section of the image pickup apparatus 60. A user 100, who is a photographer, grasps the housing 60a with a right hand 101 and performs shooting while seeing the display screen 31a of the display section 31 in a state of capturing an object within a view area.

In step S41 of FIG. 8, the control section 11 of the image pickup apparatus 60 determines whether or not a shooting mode is set. If the shooting mode is set, the control section 11 starts acquiring a through image in subsequent step S42. That is, the control section 11, based on an operation of the operation section 35 by the photographer, controls the variable magnification control section 24, the focus control section 25, and the aperture control section 26 to adjust zooming, focus, and aperture. An optical image of the object enters through a light entry face of the image pickup device 23 via the optical system 22, and the image pickup section 21 acquires a picked-up image.

The picked-up image is read by the control section 11, subjected to image processing by the image processing section 12, and thereafter supplied to the display section 31. Thus, the through image is displayed on the display screen 31a of the display section 31. Note that FIG. 10A shows that the through image is displayed on the display screen 31a. When the user 100 carries out an operation for shooting, in step S42, the recording and reproduction control section 14 starts shooting, and starts provisional recording by providing the picked-up image subjected to the signal processing by the image processing section 12 to the recording section 38.

FIG. 10B shows a movie to be provisionally recorded. FIG. 10B shows partial frames K1 to K5 of the movie acquired by the shooting. The frames K1 to K5 show the picked-up image of a candle lighting ceremony in the wedding, and the frames K4 and K5 represent frames at a timing of candle lighting.

Now, it is assumed that the user 100 desires to set a highlight candidate part at the timing of candle lighting. In this case, the user 100 only needs to operate the operation section 35 at the timing of candle lighting to designate a starting point of the highlight candidate part. For example, the editing control section 16 can be configured to identify the starting point of the highlight candidate part by the user 100 pressing a button 102 as the operation section 35 provided on a back of the housing 60a with a thumb 101T. In this case, the user 100 can specify the starting point of the highlight candidate part through an extremely easy operation of pressing the button 102 with the thumb 101T during shooting, and therefore can shoot a movie in a manner of concentrating efforts relatively on shooting operations such as composing and focusing.

When the editing control section 16 determines in step S43 that a designation operation is carried out by the user 100, the editing control section 16, at a timing of the designation operation, provisionally records an identification signal in association with the movie provisionally recorded currently (step S44). Note that the editing control section 16 may be configured to automatically identify the starting point of the highlight candidate part based on a result of image analysis by the image processing section 12 (step S43). For example, information on characteristics of an image at time of candle lighting in a candle lighting ceremony is stored in the recording section 38 beforehand, whereby the editing control section 16 can detect the timing of candle lighting and can use this timing to identify the starting point of the highlight candidate part.

In step S45, the control section 11 determines whether or not an operation for stopping shooting is carried out. When an operation for stopping shooting is not carried out, the control section 11 moves processing back to step S41 and repeats steps S41 to S45. When an operation for stopping shooting is carried out, the control section 11 performs processing for stopping shooting in step S46. After rendering a thumbnail display for checking the shooting (step S47), the control section 11 records the provisionally recorded movie and identification signal after compression processing, files the recorded movie and identification signal, and then moves processing back to step S41.

Note that when the control section 11 determines in step S41 that the shooting mode is not set, the control section 11 determines in step S49 whether or not a communication setting is instructed. If a communication setting is instructed, the control section 11 makes the communication setting necessary for communication with the mobile terminal 70 in step S50 and moves processing to step S51. If a communication setting is not instructed, the control section 11 moves processing to step S51, without making any communication setting.

In step S51, the control section 11 determines whether or not a reproduction mode is designated. If a reproduction mode is designated, the control section 11 reproduces a designated file in subsequent step S52. That is, the recording and reproduction control section 14 reads and reproduces an image recorded in the recording section 38, and provides the reproduced image to the display section 31 to display the reproduced image. Note that as in the first embodiment, identification of a highlight candidate part can be similarly performed also in the reproduction mode. For example, at time of reproduction in step S52, a highlight candidate part may be identified by performing processing as in steps S43 and S44.

It is also possible to display the reproduced image on external equipment by providing the reproduced image to the external equipment. In step S53 subsequent to step S52, the control section 11 determines whether or not external transmission is designated. If external transmission is designated, the control section 11 transmits a designated file or designated frames (step S54). If external transmission is not designated, or when the transmission in step S54 is completed, the control section 11 determines in step S55 whether or not it is instructed to stop the reproduction. If it is not instructed to stop the reproduction, the control section 11 moves processing back to step S53 and repeats steps S53 to S55. When it is instructed to stop the reproduction, the control section 11 moves processing back to step S51.

When the control section 11 determines in step S51 that a reproduction mode is not designated, the control section 11 moves processing to step S56 and determines whether or not a communication request is issued. If no communication request is issued, the control section 11 moves processing from step S56 back to step S41. When a communication request is issued, the control section 11 moves processing from step S56 to step S57 and transmits a thumbnail list to the other end of communication. Thumbnails are generated for each movie recorded in the recording section 38, and a thumbnail list shows each recorded movie.

When a selection signal is received, the control section 11 transmits a highlight candidate part of a movie corresponding to a selected thumbnail to the other end of communication (step S59). In step S60, the control section 11 determines whether or not communication is completed. If communication is not completed, the control section 11 moves processing back to step S58. When communication is completed, the control section 11 moves processing back to step S56.

Note that data transmitted in step S59 may include image data of a predetermined time period in length before and after the highlight candidate part in addition to the highlight candidate part so that the mobile terminal 70, which is the other end of communication, can change the candidate time period. In step S59, a configuration is also possible in which only image data of the identified highlight candidate part is first transmitted, and then image data before and after the highlight candidate part is transmitted in accordance with a request from the mobile terminal 70. Further, in step S59, a configuration is also possible in which a selected movie is transmitted in its entirety, and an identification signal for identifying a highlight candidate part is transmitted in association with the transmitted movie.

At events such as a wedding, it is difficult to perform highlight editing immediately after a movie is shot, in many cases. In the present embodiment, for example, after an event is finished, highlight editing can be performed by transferring necessary information to the mobile terminal 70. In addition, high degree of convenience can be provided because the mobile terminal 70 such as a smartphone can be operated on a train and the like on way home from the event, and a varied movie can be easily created.

FIG. 10C shows a state of such highlight editing. A user 110 of the mobile terminal 70, to which the image data including the highlight candidate part is transferred from the image pickup apparatus 60, grasps a housing 70a accommodating each section of the mobile terminal 70 with a left hand 111L and operates the touch panel 92 disposed on a display screen 91a of the display section 91 with a right hand finger 111R.

In step S61 of FIG. 9, the control section 71 of the mobile terminal 70 renders a mode display. In step S62, the control section 71 determines whether or not movie editing is designated. When the user 110 instructs to edit the movie, the control section 71 moves processing from step S62 to step S63, and acquires and displays the thumbnail list. That is, the control section 11 of the image pickup apparatus 60 transmits the thumbnail list in step S57, and the control section 71 of the mobile terminal 70 displays the acquired thumbnail list on the display screen 91a of the display section 91.

When the user 110 carries out an operation for selecting a predetermined thumbnail from the thumbnail list displayed on the display screen 91a, the control section 11 determines in step S64 that a thumbnail is selected, and displays the selected thumbnail in an enlarged manner. FIG. 10C shows a display example in such a case, in which a button 113 for instructing a highlight editing mode and a preview display 112a for displaying a preview of a selected image are displayed on the display screen 91a.

In step S71 subsequent to step S64, the control section 11 determines whether or not highlight editing is instructed. When the user 110 operates the button 113 by touching the button 113 with the finger 111R, the control section 11 moves processing from step S64 to step S71 and repeatedly displays the selected display highlight candidate part of the movie. Note that if a thumbnail is not selected in step S64 or if highlight editing is not instructed in step S70, the control section 11 moves processing to step S65 and determines whether or not an operation for moving processing back is carried out. When an operation for moving processing back is carried out, the control section 11 moves processing back to step S61. If an operation for moving processing back is not performed, the control section 11 moves processing back to step S64 and falls in a state of waiting for a thumbnail to be selected.

When the control section 11 determines in step S62 that movie editing is not designated, the control section 11 moves processing to step S67 and determines whether or not a communication setting or the like is designated. If a communication setting or the like is designated, the control section 11 makes the communication setting or the like in step S68. For example, when the control section 11 determines in step S67 that image reception is designated, the control section 11 receives an image in step S68. When the control section 11 determines in step S67 that a communication setting or the like is not designated, or after the processing in step S68, the control section 11 shifts to another mode.

FIG. 10D shows a display example of a repeated display of the highlight candidate part in step S71. In step S71, the editing control section 76 controls the display control section 74 so that the display shown in FIG. 10D is displayed on the display screen 91a. In the example of FIG. 10D, a preview display 112b is displayed in an upper portion of the display screen 91a, buttons 114SB and 114SF and a display 115a are displayed correspondingly to a left end of the preview display 112b, and buttons 114EB and 114EF and a display 115b are displayed correspondingly to a right end of the preview display 112b. Moreover, a decide button 116 and a return button 117 are also displayed at a lower end of the display screen 91a. Note that in the present embodiment, the preview display 112b also only needs to be able to identifiably display frames corresponding to a highlight candidate part. Accordingly, the preview display 112b may display only frames corresponding to the highlight candidate part, or may distinguishably display frames corresponding to the highlight candidate part and other frames.

The editing control section 16 causes the preview display 112b to, for example, repeatedly display the highlight candidate part of the predetermined candidate time period in length. The candidate time period may be configured to be designated by the image pickup apparatus 60, or may be configured to be set at a predetermined value by the editing control section 16. In step S72, the editing control section 16 determines whether or not an OK operation is carried out. When an operation of the decide button 116 by the user 110 is detected, the editing control section 16 determines that an OK operation is carried out, and moves processing to step S73 and records the selected highlight candidate part in the recording section 93.

When the editing control section 16 determines in step S72 that an OK operation is not carried out, the editing control section 16 determines in subsequent step S74 whether or not an operation for shifting timing is carried out. When the user 110 operates any one of the buttons 114SB, 114SF, 114EB, and 114EF by touching, the editing control section 16 moves processing to step S75 and changes the candidate time period of the highlight candidate part according to the operated button. For example, when the user 110 operates the button 114SB by touching, the editing control section 16 shifts a starting point of the highlight candidate part backward. When the user 110 operates the button 114SF by touching, the editing control section 16 shifts the starting point of the highlight candidate part forward. When the user 110 operates the button 114EB by touching, the editing control section 16 shifts an ending point of the highlight candidate part backward. When the user 110 operates the button 114EF by touching, the editing control section 16 shifts the ending point of the highlight candidate part forward.

The editing control section 16 causes the highlight candidate part, the candidate time period of which is adjusted in step S75, to be repeatedly displayed in step S71. Note that the display 115a indicates that the adjusted starting point of the highlight candidate part is three seconds earlier based on the timing of the identification signal as a reference, and the display 115b indicates that the adjusted ending point of the highlight candidate part is three seconds later based on the timing of the identification signal as a reference.

FIG. 10E shows the highlight candidate part resulting from such adjustment. The example of FIG. 10E shows that the identification signal is recorded correspondingly to a timing of the frame K4 shown in FIG. 10B, and as a result of the adjustment to the candidate time period in step S75, a total of six seconds (three seconds before and after the timing of the frame K4 each) are set for the highlight candidate part.

In step S76 subsequent to step S74, the editing control section 16 determines whether or not a return operation is carried out. When the editing control section 16 determines that the return button 117 is operated by the user 110, the editing control section 16 moves processing back to step S65, without recording the highlight candidate part. If the editing control section 16 determines in step S76 that the return button 117 is not operated, the editing control section 16 moves processing back to step S71 and repeatedly display the highlight candidate part.

In this manner, the user 110 can easily adjust the candidate time period of the highlight candidate part. Note that in this case, the highlight candidate part after the candidate time period is adjusted is recorded in the recording section 93. The editing control section 16 combines a plurality of such highlight candidate parts recorded in the recording section 93, whereby a varied and interesting movie can be easily created. In this case, as in the first embodiment, the editing control section 16 may be configured to determine highlight candidate parts to be adopted and highlight candidate parts be rejected based on a user operation and create a movie by combining only the adopted highlight candidate parts.

As described above, in the present embodiment, effects similar to the effects of the first embodiment can be obtained. In addition, since processing is performed distributedly by the image pickup apparatus and the mobile terminal, the present embodiment offers greater convenience because editing work and the like can be performed using the mobile terminal such as a smartphone, which renders an excellent screen display and provides operational ease of input operation. For example, in contrast to a stationary image pickup section, a highlight movie can be created through free operations with no restriction as to the installation location of an image pickup section. Convenience may be reduced if a high degree of freedom is not given, particularly in uses where a result of picking up an image for a long time period is unvaried, and when a change occurs, it is checked how the change develops.

It is also possible to use services of an external server, for the highlight candidate part identification processing, the highlight editing processing, and the highlight recording processing, and also for recording and the like. In this case, by allowing the external server to perform part of the processing, the processing performed by the image pickup apparatus, the mobile terminal, and the like can be reduced, and editing work can be smoothed. In addition, identification of a highlight candidate part according to a desire of a user can be implemented with high accuracy.

Note that although each embodiment of the present invention describes an example in which a digital camera is used as shooting equipment, the shooting equipment only needs to be capable of shooting a movie. The shooting equipment may be a lens-type camera, a digital single-lens reflex camera, or a digital compact camera, or may be a video camera or a movie camera. Further, the shooting equipment of course may be a built-in camera of a mobile information terminal (PDA: personal digital assist) such as a mobile telephone or a smartphone, or the like. The shooting equipment may also be optical equipment for industrial use or medical use, such as an endoscope or a microscope, or may be a surveillance camera, a vehicle-mounted camera, a stationary camera, or a camera attached to, for example, a television receiver or a personal computer.

In the embodiments, the sections may be configured by combining a dedicated circuit and a plurality of general circuits, or may be configured by combining processors such as a microprocessor and a CPU that operate in accordance with pre-programed software, or combining sequences, as necessary. A design is also possible in which part or all of control of the sections is assumed by an external apparatus, in which case a wired or wireless communication circuit is interposed. Although a communication section is not particularly described here for simplification, an embodiment is also conceivable in which the characteristic processing of the present application and supplemental processing are performed by external equipment such as a server and a personal computer. That is, the present application also covers a case where a plurality of pieces of equipment work in coordination with each other to implement the characteristic features of the present invention. For communication in such a case, Bluetooth (registered trademark), Wi-Fi (registered trademark), a telephone circuit, and the like are used. Moreover, in such a case, communication may be performed through a USB or the like. The dedicated circuit, the general circuits, and the control section may be integrated to be configured as an ASIC.

The present invention is not limited to each of the above-described embodiments as it is. In a stage of carrying out each embodiment, the constituent elements may be modified and implemented, without departing from the scope of the embodiment. Various inventions can be made by appropriately combining a plurality of the constituent elements disclosed in each of the above-described embodiments. For example, some constituent elements of all the constituent elements shown in each embodiment may be eliminated. The constituent elements in the different embodiments may be combined appropriately.

Note that “first”, “next”, “subsequently”, and the like used for convenience to describe the operation flows in claims, the description, and the drawings do not mean that the operation flows need to be followed in such order. It is needless to say that each step included in the operation flows can be appropriately omitted in parts that do not affect the nature of the invention.

Of the technologies described here, many of the controls and functions described mainly in the flowcharts can be configured by means of a program. A computer reads and executes the program, whereby the controls and functions described above can be implemented. Part or all of the program can be recorded or stored in a removable medium such as a flexible disk, a CD-ROM, or a non-volatile memory, or in a storage medium such as a hard disk or a volatile memory, as a computer program product, and can be distributed or provided at time of product shipment, or via the removable medium or a communication circuit. A user can easily implement the image recording control apparatus according to any of the embodiments by downloading the program via a communication network and installing the program in a computer, or by installing the program in a computer from the recording medium.

What is claimed is:

1. An image recording control apparatus, comprising:
an image acquisition section configured to acquire a movie; and
a processor including hardware,
wherein the processor is configured to
identify at least one image part of a specified time period in length as a record candidate part, from a beginning to an end of the movie, and
identifiably display only frames corresponding to the record candidate part to allow a time period of the record candidate part to be changed or to allow the record candidate part to be selected.

2. The image recording control apparatus according to claim 1, wherein the processor repeatedly displays the record candidate part.

3. The image recording control apparatus according to claim 1, further comprising a recording control section configured to record only a selected record candidate part among a plurality of the record candidate parts.

4. The image recording control apparatus according to claim 1, wherein the processor identifies the specified time period based on a user operation, or identifies the specified time period through image analysis of the movie.

5. The image recording control apparatus according to claim 4, wherein the processor sets a timing a predetermined time period earlier than a timing designated by the user operation or a timing designated through the image analysis, as a starting timing of the specified time period.

6. The image recording control apparatus according to claim 1, wherein the processor sets a time length of the specified time period to be a predetermined time length.

7. The image recording control apparatus according to claim 1, further comprising a time period change section configured to change the time period of the record candidate part.

8. The image recording control apparatus according to claim 1, further comprising a selection section configured to set adoption or rejection of the record candidate part.

9. The image recording control apparatus according to claim 1, further comprising an editing control section configured to change the time period of the record candidate part and to set adoption or rejection of the record candidate part.

10. The image recording control apparatus according to claim 1, further comprising a recording control section configured to record a movie obtained by combining a plurality of the record candidate parts.

11. An image recording method, comprising:
acquiring a movie;
identifying at least one image part of a specified time period in length as a record candidate part, from a beginning to an end of the movie; and
identifiably displaying only frames corresponding to the record candidate part to allow a time period of the record candidate part to be changed or to allow the record candidate part to be selected.

12. A non-transitory computer-readable recording medium storing an image recording program configured to cause a computer to execute processes of:
acquiring a movie;
identifying at least one image part of a specified time period in length as a record candidate part, from a beginning to an end of the movie; and
identifiably displaying only frames corresponding to the record candidate part to allow a time period of the record candidate part to be changed or to allow the record candidate part to be selected.

13. An image pickup apparatus, comprising:
an image pickup section configured to acquire a movie; and
a processor including hardware,
wherein the processor is configured to
identify at least one image part of a specified time period in length as a record candidate part, from a beginning to an end of the movie, and
identifiably display only frames corresponding to the record candidate part to allow a time period of the record candidate part to be changed or to allow the record candidate part to be selected.

14. The image pickup apparatus according to claim 13, wherein the processor displays the frames corresponding to the record candidate part immediately after image pickup for the movie performed by the image pickup section is completed.

15. The image pickup apparatus according to claim 14, wherein the processor is configured to provide a graphical user interface to allow the time period of the record candidate part to be changed or to allow the record candidate part to be selected when the processor displays the frames corresponding to the record candidate part.

16. An image recording control system, comprising:
an image pickup apparatus configured to acquire a movie; and
an information terminal apparatus including a display and capable of communication with the image pickup apparatus,
wherein the image recording control system further comprises:
a first processor provided in the image pickup apparatus or the information terminal apparatus and including hardware configured to identify at least one image part of a specified time period in length as a record candidate part, from a beginning to an end of the movie; and
a second processor provided in the image pickup apparatus or the information terminal apparatus and including hardware configured to identifiably display only frames corresponding to the record candidate part to allow a time period of the record candidate part to be changed or to allow the record candidate part to be selected.
